(19) United States
(12) Patent Application Publication
(10) Pub. No.: US 2004/0083315 A1
(43) Pub. Date: Apr. 29, 2004

(54) Integrated circuit for a multi-function handheld device

(76) Inventors: Aaron Grassian, Austin, TX (US); Daniel Mulligan, Austin, TX (US); Marcus W. May, Austin, TX (US)

Correspondence Address: Timothy W. Markison, P.O. Box 160727, Austin, TX, 78716-0727, US

(21) Appl. No.: 10/280,254

(22) Filed: Oct. 25, 2002

(51) Int. Cl. G06F 3/00

(52) U.S. Cl. 710/14

(57) ABSTRACT

An integrated circuit for a multi-function handheld device includes a host interface, a bus, a processing module, a memory interface, a multimedia module, and a DC-to-DC converter. The host interface is operable to receive or transmit data with a host device when the multi-function handheld device is operably coupled to the host device. The processing module functions to place the multi-function handheld device in a first functional mode when the host interface is operably coupled to the host device and places the multi-function handheld device in a second functional mode when the host interface is not operably coupled to the host device. The memory interface is operably coupled to, when the multi-function handheld device is in the first functional mode, provide data received from the host device to memory for storage. The memory interface also provides data retrieved from the memory to the host interface for transmission to the host device. The multimedia module is operably coupled to, when the multi-function handheld device is in the second functional mode, to convert data stored in the memory into rendered output data.

This patent application is claim priority under 35 USC § 120 to copending patent applications:

(1) entitled METHOD AND APPARATUS FOR IMPROVED POWER EFFICIENCY OF A PROCESSING CIRCUIT, having a filing date of Jul. 31, 2000, and an application Ser. No. 09/628,847; and

(2) entitled A METHOD AND APPARATUS FOR ENABLING A STAND ALONE INTEGRATED CIRCUIT, having a filing date of Nov. 20, 2000, and having an application Ser. No. 09/716,731.

### BACKGROUND OF THE INVENTION

1. Technical Field of the Invention

This invention relates generally to portable electronic equipment and more particularly to an integrated circuit for use in a multi-function handheld device.

2. Description of Related Art

As is known, integrated circuits are used in a wide variety of electronic equipment, including portable, or handheld, devices. Such handheld devices include personal digital assistants (PDA), CD players, MP3 players, DVD players, AM/FM radio, a pager, cellular telephones, computer memory extension (commonly referred to as a thumb drive), etc. Each of these handheld devices include one or more integrated circuits to provide the functionality of the device. For example, a thumb drive may include an integrated circuit for interfacing with a computer (e.g., personal computer, laptop, server, workstation, etc.) via one of the ports of the computer (e.g., Universal Serial Bus, parallel port, etc.) and at least one other memory integrated circuit (e.g., flash memory). As such, when the thumb drive is coupled to a computer, data can be read from and written to the memory of the thumb drive. Accordingly, a user may store personalized information (e.g., presentations, Internet access account information, etc.) on his/her thumb drive and use any computer to access the information.

As another example, an MP3 player may include multiple integrated circuits to support the storage and playback of digitally formatted audio (i.e., formatted in accordance with the MP3 specification). As is known, one integrated circuit may be used for interfacing with a computer, another integrated circuit for generating a power supply voltage, another for processing the storage and/or playback of the digitally formatted audio data, and still another for rendering the playback of the digitally formatted audio data audible.

Integrated circuits have enabled the creation of a plethora of handheld devices, however, to be “wired” in today's electronic world, a person needs to posses multiple handheld devices. For example, one may own a cellular telephone for cellular telephone service, a PDA for scheduling, address book, etc., one or more thumb drives for extended memory functionality, an MP3 player for storage and/or playback of digitally recorded music, a radio, etc. Thus, even though a single handheld device may be relatively small, carrying multiple handheld devices on one's person can become quite burdensome.

Therefore, a need exists for integrated circuits that provide multiple functions for handheld devices, associated operations of the integrated circuits, and applications of the integrated circuits.

### BRIEF SUMMARY OF THE INVENTION

The integrated circuit for a multi-function handheld device of the present invention substantially meets these needs and others. An embodiment of the integrated circuit includes a host interface, a bus, a processing module, a memory interface, a multimedia module, and a DC-to-DC converter. The host interface is operable to receive or transmit data with a host device (e.g., personal computer, laptop computer, etc.) when the multi-function handheld device is operably coupled to the host device. The bus provides a medium for transmitting and/or receiving data between the host interface, the processing module, and the memory interface. The processing module functions to place the multi-function handheld device in a first functional mode when the host interface is operably coupled to the host device and places the multi-function handheld device in a second functional mode when the host interface is not operably coupled to the host device.

The memory interface is operably coupled to, when the multi-function handheld device is in the first functional mode, provide data received from the host device to memory coupled to the integrated circuit for storage. The memory interface also provides data retrieved from the memory to the host interface for transmission to the host device. The multimedia module is operably coupled to, when the multi-function handheld device is in the second functional mode, to convert data stored in the memory into rendered output data (e.g., prepares the data to be heard or seen). The DC to DC converter is operably coupled to provide at least a first supply voltage to at least one of the host interface, the processing module, the memory interface, and the multimedia module. With such an integrated circuit, a handheld device may provide multiple functions, thus reducing the burdens of handheld device users.

An embodiment of a handheld device includes the integrated circuit, a battery, and memory, which is coupled to the integrated circuit via the memory interface. The battery is operably coupled to the DC-to-DC converter, which produces therefrom the supply voltage(s) for the integrated circuit. The handheld device may further include a clock source, a speaker, a headphone jack, a microphone, a display, a video capture device, and/or an user input module (e.g., key pad).

### BRIEF DESCRIPTION OF THE SEVERAL VIEWS OF THE DRAWINGS

FIG. 1 is a schematic block diagram of a handheld device and corresponding integrated circuit in accordance with the present invention;

FIG. 2 is a schematic block diagram of another handheld device and corresponding integrated circuit in accordance with the present invention;

FIG. 3 is a schematic block diagram of another integrated circuit in accordance with the present invention; and

FIG. 4 is a logic diagram of a method for providing multiple functions for a handheld device in accordance with the present invention.

### DETAILED DESCRIPTION OF THE INVENTION

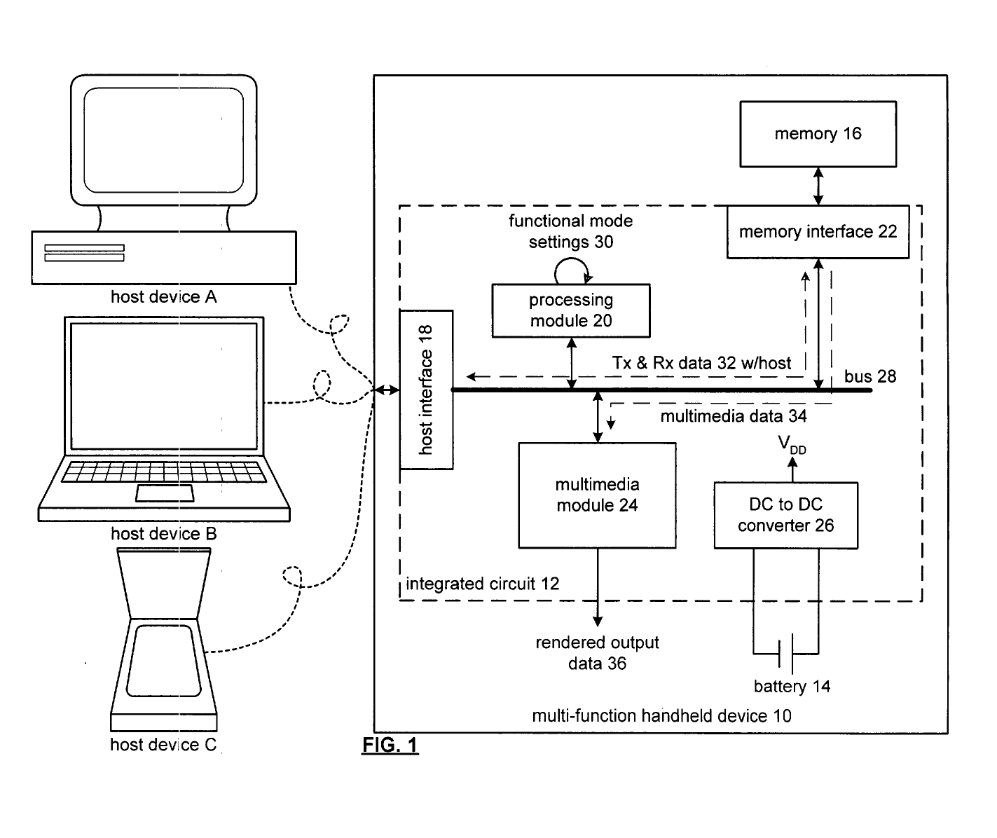

FIG. 1 is a schematic block diagram of a multi-function handheld device 10 and corresponding integrated circuit 12 operably coupled to a host device A, B, or C. The multi-function handheld device 10 also includes memory 16 and a battery 14. The integrated circuit 12 includes a host interface 18, a processing module 20, a memory interface 22, a multimedia module 24, a DC-to-DC converter 26, and a bus 28. The multimedia module 24 alone or in combination with the processing module 20 provides the functional circuitry for the integrated circuit 12. The DC-to-DC converter 26, which may be constructed in accordance with the teaching of U.S. Pat. No. 6,204,651, entitled METHOD AND APPARATUS FOR REGULATING A DC VOLTAGE, provides at least a first supply voltage to one or more of the host interface 18, the processing module 20, the multimedia module 24, and the memory interface 22. The DC-to-DC converter 26 may also provide V_{DD} to one or more of the other components of the handheld device 10.

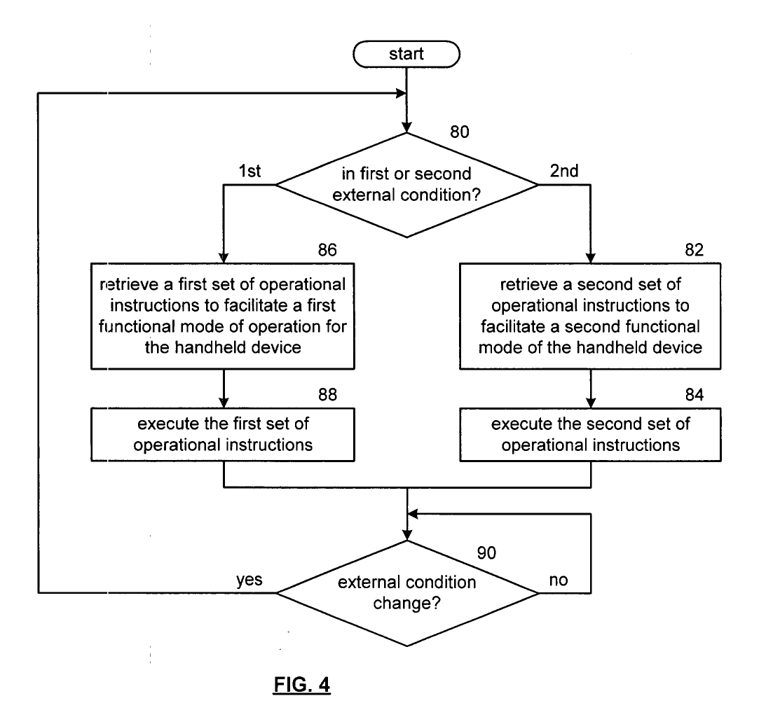

When the multi-function handheld device 10 is operably coupled to a host device A, B, or C, which may be a personal computer, workstation, server (which are represented by host device A), a laptop computer (host device B), a personal digital assistant (host device C), and/or any other device that may transceive data with the multi-function handheld device, the processing module 20 performs an functional mode setting algorithm 30 to place the integrated circuit 12 in a first functional mode. The functional mode setting algorithm 30 will be described in greater detail with reference to FIG. 4, where the corresponding operational instructions of the algorithm 30 are stored in memory 16 and/or in memory incorporated in the processing module 20. The processing module 20 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 20 implements one or more of its functions via a state machine, analog circuitry, digital circuitry, and/or logic circuitry, the associated memory storing the corresponding operational instructions is embedded with the circuitry comprising the state machine, analog circuitry, digital circuitry, and/or logic circuitry.

With the multi-function handheld device 10 in the first functional mode, the integrated circuit 12 facilitates the transfer of data between the host device A, B, or C and memory 16, which may be non-volatile memory (e.g., flash memory, disk memory, SDRAM) and/or volatile memory (e.g., DRAM). In this mode, the processing module 30 retrieves a first set of operational instructions (e.g., a file system algorithm, which is known in the art) from the memory 16 to coordinate the transfer of data. For example, data received from the host device A, B, or C (e.g., Rx data) is first received via the host interface module 18. Depending on the type of coupling between the host device and the handheld device 10, the received data will be formatted in a particular manner. For example, if the handheld device 10 is coupled to the host device via a USB cable, the received data will be in accordance with the format proscribed by the USB specification. The host interface module 18 converts the format of the received data (e.g., USB format) into a desired format by removing overhead data that corresponds to the format of the received data and storing the remaining data as data words. The size of the data words generally corresponds directly to, or a multiple of, the bus width of bus 28 and the word line size (i.e., the size of data stored in a line of memory) of memory 16. Under the control of the processing module 20, the data words are provided, via the memory interface 22, to memory 16 for storage. In this mode, the handheld device 10 is functioning as extended memory of the host device (e.g., like a thumb drive).

In furtherance of the first functional mode, the host device may retrieve data (e.g., Tx data) from memory 16 as if the memory were part of the computer. Accordingly, the host device provides a read command to the handheld device, which is received via the host interface 18. The host interface 18 converts the read request into a generic format and provides the request to the processing module 20. The processing module 20 interprets the read request and coordinates the retrieval of the requested data from memory 16 via the memory interface 22. The retrieved data (e.g., Tx data) is provided to the host interface 18, which converts the format of the retrieved data from the generic format of the handheld device into the format of the coupling between the handheld device and the host device. The host interface 18 then provides the formatted data to the host device via the coupling.

The coupling between the host device and the handheld device may be a wireless connection or a wired connection. For instance, a wireless connection may be in accordance with Bluetooth, IEEE 802.11(a), (b) or (g), and/or any other wireless LAN (local area network) protocol, IrDA, etc. The wired connection may be in accordance with one or more Ethernet protocols, Firewire, USB, etc. Depending on the particular type of connection, the host interface module 18 includes a corresponding encoder and decoder. For example, when the handheld device 10 is coupled to the host device via a USB cable, the host interface module 18 includes a USB encoder and a USB decoder.

As one of average skill in the art will appreciate, the data stored in memory 16, which may have 64 Mbytes or greater of storage capacity, may be text files, presentation files, user profile information for access to varies computer services (e.g., Internet access, email, etc.), digital audio files (e.g., MP3 files, WMA—Windows Media Architecture-, mp3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format. As one of average skill in the art will further appreciate, when the handheld device 10 is coupled to the host device A, B, or C, the host device may power the handheld device 10 such that the battery is unused.

When the handheld device 10 is not coupled to the host device, the processing module 20 executes the function mode setting algorithm 30 to detect the disconnection and to place the handheld device in a second operational mode. In the second operational mode, the processing module 20 retrieves, and subsequently executes, a second set of operational instructions from memory 16 to support the second operational mode. For example, the second operational mode may correspond to MP3 file playback, digital dictaphone recording, MPEG file playback, JPEG file playback, text messaging display, cellular telephone functionality, and/or AM/FM radio reception. Each of these functions is known in the art, thus no further discussion of the particular implementation of these functions will be provided except to further illustrate the concepts of the present invention.

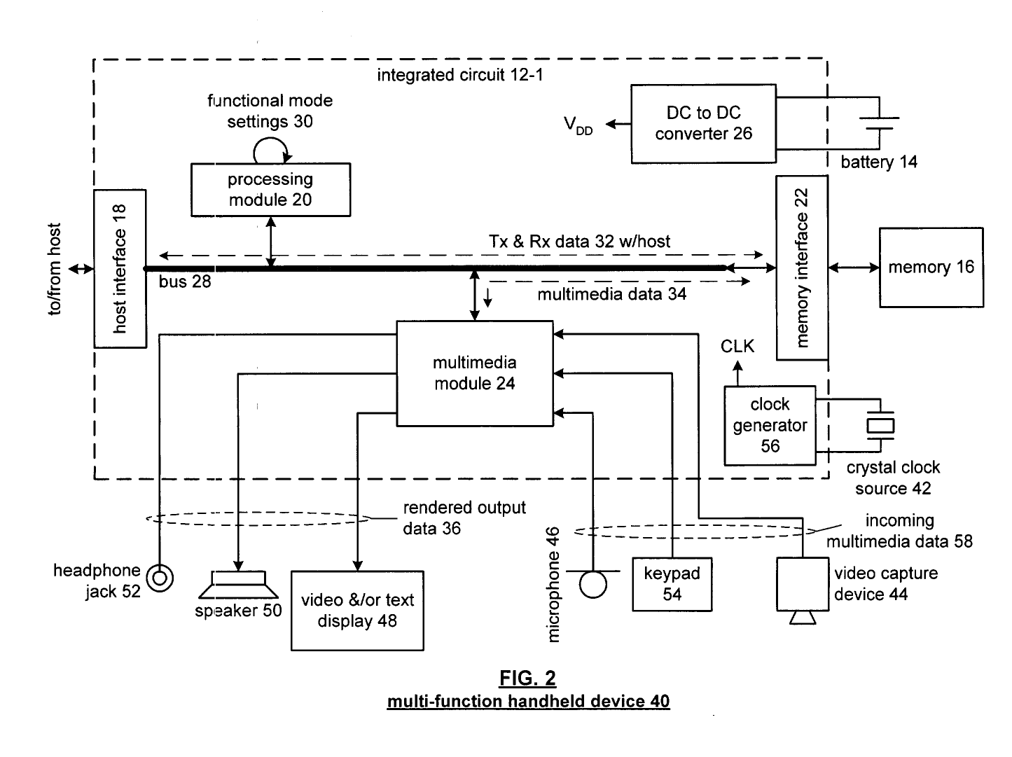

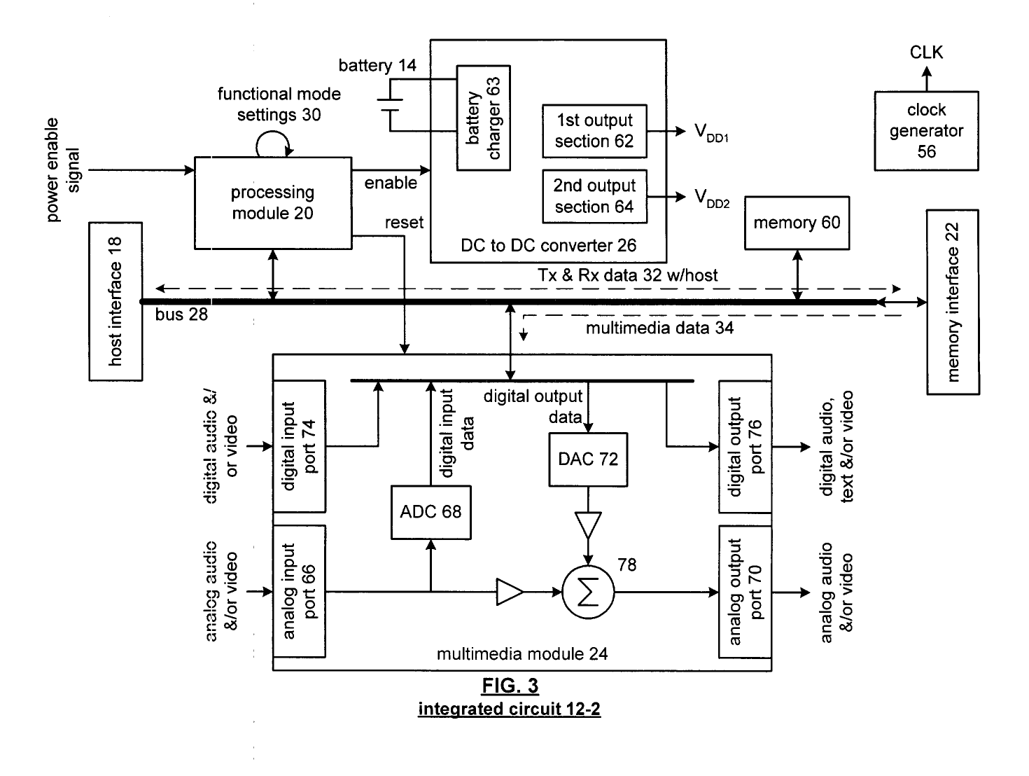

In the second operational mode, under the control of the processing module 20 executing the second set of operational instructions, the multimedia module 24 retrieves multimedia data 34 from memory 16. The multimedia data 34 includes at least one of digitized audio data, digital video data, and text data. Upon retrieval of the multimedia data, the multimedia module 24 converts the data 34 into rendered output data 36. For example, the multimedia module 24 may convert digitized data into analog signals that are subsequently rendered audible via a speaker or via a headphone jack. In addition, or in the alternative, the multimedia module 24 may render digital video data and/or digital text data into RGB (red-green-blue), YUV, etc., data for display on an LCD (liquid crystal display) monitor, projection CRT, and/or on a plasma type display. The multimedia module 24 will be described in greater detail with reference to FIGS. 2 and 3.

As one of average skill in the art, the handheld device 10 may be packaged similarly to a thumb drive, a cellular telephone, pager (e.g., text messaging), a PDA, an MP3 player, a radio, and/or a digital dictaphone and offer the corresponding functions of multiple ones of the handheld devices (e.g., provide a combination of a thumb drive and MP3 player/recorder, a combination of a thumb drive, MP3 player/recorder, and a radio, a combination of a thumb drive, MP3 player/recorder, and a digital dictaphone, combination of a thumb drive, MP3 player/recorder, radio, digital dictaphone, and cellular telephone, etc.).

FIG. 2 is a schematic block diagram of another handheld device 40 and a corresponding integrated circuit 12-1. In this embodiment, the handheld device 40 includes the integrated circuit 12-1, the battery 14, the memory 16, a crystal clock source 42, one or more multimedia input devices (e.g., one or more video capture device(s) 44, keypad(s) 54, microphone(s) 46, etc.), and one or more multimedia output devices (e.g., one or more video and/or text display(s) 48, speaker(s) 50, headphone jack(s) 52, etc.). The integrated circuit 12-1 includes the host interface 18, the processing module 20, the memory interface 22, the multimedia module 24, the DC-to-DC converter 26, and a clock generator 56, which produces a clock signal (CLK) for use by the other modules. As one of average skill in the art will appreciate, the clock signal CLK may include multiple synchronized clock signals at varying rates for the various operations of the multi-function handheld device.

Handheld device 40 functions in a similar manner as handheld device 10 when exchanging data with the host device (i.e., when the handheld device is in the first operational mode). In addition, while in the first operational mode, the handheld device 40 may store digital information received via one of the multimedia input devices 44, 46, and 54. For example, a voice recording received via the microphone 46 may be provided as multimedia input data 58, digitized via the multimedia module 24 and digitally stored in memory 16. Similarly, video recordings may be captured via the video capture device 44 (e.g., a digital camera, a camcorder, VCR output, DVD output, etc.) and processed by the multimedia module 24 for storage as digital video data in memory 16. Further, the key pad 54 which may be a keyboard, touch screen interface, or other mechanism for inputting text information) provides text data to the multimedia module 24 for storage as digital text data in memory 16. In this extension of the first operational mode, the processing module 20 arbitrates write access to the memory 16 among the various input sources (e.g., the host and the multimedia module).

When the handheld device 40 is in the second operational mode (i.e., not connected to the host), the handheld device may record and/or playback multimedia data stored in the memory 16. Note that the data provided by the host when the handheld device 40 was in the first operational mode includes the multimedia data. The playback of the multimedia data is similar to the playback described with reference to the handheld device 10 of FIG. 1. In this embodiment, depending on the type of multimedia data 34, the rendered output data 36 may be provided to one or more of the multimedia output devices. For example, rendered audio data may be provided to the headphone jack 52 an/or to the speaker 50, while rendered video and/or text data may be provided to the display 48.

The handheld device 40 may also record multimedia data 34 while in the second operational mode. For example, the handheld device 40 may store digital information received via one of the multimedia input devices 44, 46, and 54.

FIG. 3 is a schematic block diagram of an integrated circuit 12-2 that may be used in a multi-function handheld device. The integrated circuit 12-2 includes the host interface 18, the processing module 20, the DC-to-DC converter 26, memory 60, the clock generator 56, the memory interface 22, the bus 28 and the multimedia module 24. The DC-to-DC converter 26 includes a first output section 62, and a second output section 64 to produce a first and second output voltage (V_{DD1} and V_{DD2}), respectively. Typically, V_{DD1} will be greater that V_{DD2}, where V_{DD1} is used to source analog sections of the processing module 20, the host interface 18, the memory interface 22, and/or the multimedia module 22 and V_{DD2} is used to source the digital sections of these modules. The DC-to-DC converter 26 may further include a battery charger 63 that, when the multi-function handheld device is physically coupled to the host device (e.g., via a USB cable), the battery charger 63 is operable to charge the battery 14 from power it receives via the physical coupling to the host device. The particular implementation of the battery charger 63 is dependent on the type of battery being used and such implementations are known in the art, thus no further discussion will be provided regarding the battery charger 63 except to further illustrate the concepts of the present invention.

The multimedia module 24 includes an analog input port 66, an analog to digital converter (ADC) 68, an analog output port 70, a digital to analog converter (DAC) 72, a digital input port 74, a digital output port 76, and an analog mixing module 78. The analog input port 66 is operably coupled to receive analog input signals from one or more sources including a microphone, an AM/FM tuner, a line in connection (e.g., headphone jack of a CD player), etc. The received analog signals are provided to the ADC 68, which produces digital input data therefrom. The digital input data may be in a pulse code modulated (PCM) format and stored as such, or it may be provided to the processing module 20 for further audio processing (e.g., compression, MP3 formatting, etc.) The digital input data, or the processed version thereof, is stored in memory 16 as instructed by the processing module 20.

The digital input port 74 is operably coupled to receive digital audio and/or video input signals from, for example, a digital camera, a camcorder, etc. The digital audio and/or video input signals may stored in memory 16 under the control of the processing module 20. As one of average skill in the art will appreciate, the audio and/or video data (which was inputted as analog signals or digital signals) may be stored as raw data (i.e., the signals received are stored as is in designated memory locations) or it may be stored as processed data (i.e., compressed data, MPEG data, MP3 data, etc.).

The DAC 72 receives multimedia data 34 as digital output data and converts it into analog video and/or audio output data that is provided to the mixing module 78. When the output of the DAC 72 is the only input to the mixing module 78, the mixing module 78 outputs the analog video and/or audio output data to the analog output port 70. The analog output port 70 may be coupled to one or more of the speaker, headphone jack, and a video display. The mixing module 78 may mix analog input signals received via the analog input port 66 with the output of DAC 72 to produce a mixed analog signal that is provided to the analog output port 70. Note that the buffers in series with the inputs of the mixing module 78 may have their gains adjusted and/or muted to enable selection of the signals at various gain settings provided to the mixing module 78 and subsequently outputted via the analog output port 70.

The digital output port 76 is operably coupled to output the digital output data (i.e., the multimedia data 34 in a digital format). The digital output port 76 may be coupled to a digital input of a video display device, another handheld device for direct file transfer, etc.

As one of average skill in the art will appreciate, the multimedia module 24 may include less than the components shown in FIG. 3 or include multiple analog and/or digital input and/or output ports. For example, for a playback mode of digital audio files, the multimedia module 24 may only include the DAC 72 and the analog output port 70 that is coupled to the headphone jack and/or to the speaker. As another example, for recording voice samples (i.e., as a digital dictaphone), the multimedia module 24 may include the analog input port 66 coupled to the microphone and the ADC.

FIG. 4 is a logic diagram of a method for providing multiple functions for a handheld. The process begins at step 80, where the integrated circuit of the handheld device determines whether a first or a second external condition exists for the handheld device. The first external condition may correspond to the handheld device being coupled to a host device and the second external condition may correspond to the handheld device not being coupled to the host device. The first or second external condition may be detected by detecting the operable connection of the handheld device to a host device (i.e., the processing module monitors the host interface to detect the presence of a supply voltage or other type of signal from the host device). When the supply voltage or other type of signal is detected, the processing module determines that the handheld device is coupled to the host device. Alternatively, the host device may provide a specific input command to place the handheld device in the first or second mode. Still further, the multi-function handheld device may use a timer to periodically check whether it is connected to the host via sensing a connection or receiving a command. Note that the connection between the host device and the handheld device may be a serial port connection, a parallel port connection, a wireless connection, or an infrared connection.

If it is determined that the first external condition exists, the process proceeds to step 86 where the integrated circuit retrieves a first set of operational instructions to facilitate a first functional mode of operation for the handheld device. The first set of operational instructions may correspond to a file system algorithm that facilitates the handheld device function as a mass storage device for the host device. The process then proceeds to step 88, where the integrated circuit executes the first set of operational instructions. The process then proceeds to step 90 where the integrated circuit determines whether the external condition has changed. In this instance, the inquiry is whether the handheld device is still coupled to the host device or not. If it is still connected, the integrated circuit continues executing the first set of operational instructions and testing for the external condition to change. When the external condition changes, the process reverts to step 80.

If the second external condition exists, the process proceeds to step 82, where the integrated circuit retrieves a second set of operational instructions to facilitate a second functional mode of the handheld device. For example, the second set of operational instructions may correspond to an MP3 algorithm such that the handheld device functions as an MP3 player/recorder. The process then proceeds to step 84 where the integrated circuit executes the second set of operational instructions. The process then proceeds to step 90, where the integrated circuit determines whether the external condition has changed. In this instance, is the handheld device coupled to the host device. If not, the integrated circuit continues executing the second set of operational instructions and testing for the external condition to change. When external condition changes, the process reverts to step 80.

As an alternative to determining whether the multi-function handheld device is the first or second mode, the handheld device may simultaneously be in both modes. For example, the multi-function handheld device may be transceiving data with the host device via a connection (e.g., USB, wireless, etc.) and playing back stored video, audio, and/or text data. Further, the multi-function handheld device may be recording video, audio, and/or text data while transceiving data with the host device.

The preceding discussion has presented various embodiments of an integrated circuit that enables a handheld device to facilitate multiple modes of functionality. As one of average skill in the art will appreciate, other embodiments may be derived from the teachings of the present invention without deviating from the scope of the claims.

What is claimed is:

1. An integrated circuit for a multi-function handheld device comprises:
a host interface operable to receive or transmit data with a host device when the multi-function handheld device is operably coupled, via the host interface, to the host device;
a bus operably coupled to the host interface;
processing module operably coupled to the bus, wherein the processing module places the multi-function handheld device in a first functional mode when the host interface is operably coupled to the host device and places the multi-function handheld device in a second functional mode when the host interface is not operably coupled to the host device;
memory interface operably coupled to the bus and memory, wherein, when the multi-function handheld device is in the first functional mode, the memory interface provides received data of the data received from the host device to the memory for storage and provides transmitting data of the data transmitted to the host device from the memory to the host interface via the bus;
multimedia module operably coupled to the bus, wherein, when the multi-function handheld device is in the second functional mode, the multimedia module converts multimedia data of the data stored in the memory into rendered output data; and
DC to DC converter operably coupled to provide at least a first supply voltage to at least one of the host interface, the processing module, the memory interface, and the multimedia module.

2. The integrated circuit of claim 1, wherein the memory further comprises at least one of on-chip memory and off-chip memory.

3. The integrated circuit of claim 1, wherein the multimedia data further comprises at least one of digitized audio data, digital video data, and text data.

4. The integrated circuit of claim 1, wherein the multimedia module further functions to receive incoming multimedia data and provide, in a digital format, the incoming multimedia data to the memory.

5. The integrated circuit of claim 1 further comprises:
the first functional mode including the multi-function handheld device functioning as extended memory for the host device;
the second functional mode including a playback mode for playback of the multimedia data stored in the memory.

6. The integrated circuit of claim 5, wherein the second functional mode further comprises:
a record mode for receiving incoming multimedia data and storing, in a digital form, the incoming multimedia data in the memory.

7. The integrated circuit of claim 1, wherein the memory further comprises at least one of non-volatile memory and volatile memory.

8. The integrated circuit of claim 1, wherein the DC to DC further comprises:
a first output section that produces a first supply voltage for at least the processing module; and
a second output section that produces a second supply voltage for at least the multimedia module.

9. The integrated circuit of claim 1, wherein the multimedia module further comprises at least one of:
an analog input port for receiving at least one of analog video data and analog audio data;
an analog to digital converter coupled to the bus and the analog input port, wherein the analog to digital convert converts the at least one of the analog video data and analog audio data into digital data;
an analog output port for providing at least one of analog output video data and analog output audio data;
digital to analog converter operably coupled to the bus and to the analog output port, wherein the digital to analog converter converts output digital data into the at least one of analog output video data and analog output audio data;
analog mixer operably coupled to mix one or more of the analog video data, the analog audio data, the analog output video data, and the analog output audio data to produce a mixed analog signal, wherein the mixed analog signal is provided to the analog output port;
digital input port coupled to the bus, wherein the digital input port receives at least one of digital input video data and digital input audio data; and
digital output port coupled to the bus, wherein the digital output port outputs at least one of digital output video data, digital text data, and digital output audio data.

10. The integrated circuit of claim 1, wherein the memory further comprises a section to store operational instructions that cause the processing module to facilitate the multi-function handheld device to function as a mass storage device in the first function mode and to facilitate the multi-function handheld device to function as an MP3 player/recorder in the second functional mode.

11. The integrated circuit of claim 1, wherein the DC-to-DC converter further comprises:
battery charger circuit operably coupled to charge a battery when the multi-function handheld device is operably coupled to the host device, wherein power for charging the battery is supplied by the host device.

12. A multi-function handheld device comprises:
an integrated circuit;
a battery operably coupled to provide a supply voltage to the integrated circuit;
memory operably coupled to the integrated circuit, wherein the integrated circuit includes:
a host interface operable to receive or transmit data with a host device when the multi-function handheld device is operably coupled, via the host interface, to the host device;
a bus operably coupled to the host interface;
processing module operably coupled to the bus, wherein the processing module places the multi-function handheld device in a first functional mode when the host interface is operably coupled to the host device and places the multi-function handheld device in a second functional mode when the host interface is not operably coupled to the host device;
memory interface operably coupled to the bus and the memory, wherein, when the multi-function handheld device is in the first functional mode, the memory interface provides received data of the data received from the host device to the memory for storage and provides transmitting data of the data transmitted to the host device from the memory to the host interface via the bus;
multimedia module operably coupled to the bus, wherein, when the multi-function handheld device is in the second functional mode, the multimedia module converts multimedia data of the data stored in the memory into rendered output data; and
DC to DC converter operably coupled to provide at least a first supply voltage to at least one of the host interface, the processing module, the memory interface, and the multimedia module.

13. The multi-function handheld device of claim 12 further comprises at least one:
a clock source operably coupled to the integrated circuit, wherein the clock source provides a reference clock to the integrated circuit;
at least one speaker coupled to the integrated circuit, wherein the speaker renders the multimedia data audible;
at least one microphone operably coupled to the integrated circuit, wherein the at least one microphone provides analog audio signals to the multimedia module, wherein the multimedia module converts the analog audio signals into a digital format for storage in the memory;
a display for displaying at least one video data and text data of the multimedia data;
video capture device operable to capture video images in a digital format and to provide digital video of the captured video images to the multimedia module, wherein the multimedia module provides the digital video to the memory interface for storage in the memory; and
input module operable to convert user inputs into text information and to provide the text information to the multimedia module, wherein the multimedia module provides the text information to the memory interface for storage in the memory.

14. The multi-function handheld device of claim 12 further comprises:
the first functional mode including the multi-function handheld device functioning as extended memory for the host device;
the second functional mode including a playback mode for playback of the multimedia data stored in the memory.

15. The multi-function handheld device of claim 12, wherein the second functional mode further comprises:
a record mode for receiving incoming multimedia data and storing, in a digital form, the incoming multimedia data in the memory.

16. The multi-function handheld device of claim 12, wherein the DC to DC further comprises:
a first output section that produces a first supply voltage for at least the processing module; and
a second output section that produces a second supply voltage for at least the multimedia module.

17. The multi-function handheld device of claim 12, wherein the multimedia module further comprises at least one of:
an analog input port for receiving at least one of analog video data and analog audio data;
an analog to digital converter coupled to the bus and the analog input port, wherein the analog to digital converter converts the at least one of the analog video data and analog audio data into digital data;
an analog output port for providing at least one of analog output video data and analog output audio data;
digital to analog converter operably coupled to the bus and to the analog output port, wherein the digital to analog converter converts output digital data into the at least one of analog output video data and analog output audio data;
analog mixer operably coupled to mix one or more of the analog video data, the analog audio data, the analog output video data, and the analog output audio data to produce a mixed analog signal, wherein the mixed analog signal is provided to the analog output port;
digital input port coupled to the bus, wherein the digital input port receives at least one of digital input video data and digital input audio data; and
digital output port coupled to the bus, wherein the digital output port outputs at least one of digital output video data, digital text data, and digital output audio data.

18. The multi-function handheld device of claim 12, wherein the memory further comprises a section to store operational instructions that cause the processing module to facilitate the multi-function handheld device to function as a mass storage device in the first function mode and to facilitate the multi-function handheld device to function as an MP3 player/recorder in the second functional mode.

19. The multi-function handheld device of claim 12, wherein the DC-to-DC converter further comprises:
battery charger circuit operably coupled to charge a battery when the multi-function handheld device is operably coupled to the host device, wherein power for charging the battery is supplied by the host device.

20. A method for providing multiple functions for a handheld device, the method comprises:
detecting a first external condition;
retrieving a first set of operational instructions to facilitate a first functional mode of operation for the handheld device;
detecting a second external condition; and
retrieving a second set of operational instructions to facilitate a second functional mode of the handheld device.

21. The method of claim 20, wherein the detecting the first external condition further comprises at least one of:
detecting the operable connection of the handheld device to a host device; and
detecting an input command.

22. The method of claim 21, wherein the detecting the operable connection further comprises at least one of:
detecting a serial port connection between the handheld device and the host device;
detecting a parallel port connection between the handheld device and the host device;
detecting a wireless connection between the handheld device and the host device; and
detecting an infrared connection between the handheld device and the host device.

23. The method of claim 21, wherein the detecting a second external condition further comprises at least one of:
detecting absence of the operable connection; and
detecting a second input command.

24. The method of claim 20 further comprises:
retrieving, as the first set of operational instructions, a file system algorithm to facilitate a mass storage device mode of operation for the handheld device; and
retrieving, as the second set of operational instructions, an MP3 algorithm to facilitate an MP3 player/recorder mode of operation for the handheld device.

25. An apparatus for providing multiple functions for a handheld device, the apparatus comprises:
means for detecting a first external condition;
means for retrieving a first set of operational instructions to facilitate a first functional mode of operation for the handheld device;
means for detecting a second external condition; and
means for retrieving a second set of operational instructions to facilitate a second functional mode of the handheld device.

26. The apparatus of claim 25, wherein the means for detecting the first external condition further functions to detect at least one of:
the operable connection of the handheld device to a host device; and
an input command.

27. The apparatus of claim 26, wherein the means for detecting the operable connection further functions to detect at least one at least one of:
a serial port connection between the handheld device and the host device;
a parallel port connection between the handheld device and the host device;
a wireless connection between the handheld device and the host device; and
an infrared connection between the handheld device and the host device.

28. The apparatus of claim 26, wherein the means for detecting a second external condition further functions to detect at least one of:
absence of the operable connection; and
a second input command.

29. The apparatus of claim 25 further comprises:
the means for retrieving the first set of operational instructions retrieving a file system algorithm to facilitate a mass storage device mode of operation for the handheld device; and
the means for retrieving the second set of operational instructions retrieving an MP3 algorithm to facilitate an MP3 player/recorder mode of operation for the handheld device.

30. An integrated circuit for a multi-function handheld device comprises:
a host interface operable to receive or transmit data with a host device when the multi-function handheld device is operably coupled, via the host interface, to the host device;
a bus operably coupled to the host interface;
processing module operably coupled to the bus, wherein the processing module enables the multi-function handheld device to function in at least one of a first functional mode and a second functional mode, wherein the first functional mode enables the multi-function handheld device to transceived data via the host interface with the host device and wherein the second functional module enables the multi-function handheld device to at least one of playback stored data and record data;
memory interface operably coupled to the bus and memory, wherein, when the multi-function handheld device is in the first functional mode, the memory interface provides received data of the data received from the host device to the memory for storage and provides transmitting data of the data transmitted to the host device from the memory to the host interface via the bus, and wherein, when the multi-function handheld device is in the second functional mode, the memory interface retrieves the stored data from the memory for playback and provides the record data for storage in the memory;
multimedia module operably coupled to the bus, wherein, when the multi-function handheld device is in the second functional mode, the multimedia module processes the stored data for playback and processes the record data for storage in the memory; and
DC to DC converter operably coupled to provide at least a first supply voltage to at least one of the host interface, the processing module, the memory interface, and the multimedia module.

31. The integrated circuit of claim 30, wherein the memory further comprises at least one of on-chip memory and off-chip memory.

32. The integrated circuit of claim 30, wherein the stored data for playback further comprises at least one of digitized audio data, digital video data, and text data.

33. The integrated circuit of claim 30 further comprises:
the first functional mode including the multi-function handheld device functioning as extended memory for the host device;
the second functional mode including a playback mode for playback of stored MP3 data.

34. The integrated circuit of claim 30, wherein the memory further comprises at least one of non-volatile memory and volatile memory.

35. The integrated circuit of claim 30, wherein the multimedia module further comprises at least one of:
an analog input port for receiving at least one of analog video data and analog audio data;
an analog to digital converter coupled to the bus and the analog input port, wherein the analog to digital convert converts the at least one of the analog video data and analog audio data into digital data;
an analog output port for providing at least one of analog output video data and analog output audio data;
digital to analog converter operably coupled to the bus and to the analog output port, wherein the digital to analog converter converts output digital data into the at least one of analog output video data and analog output audio data;
analog mixer operably coupled to mix one or more of the analog video data, the analog audio data, the analog output video data, and the analog output audio data to produce a mixed analog signal, wherein the mixed analog signal is provided to the analog output port;
digital input port coupled to the bus, wherein the digital input port receives at least one of digital input video data and digital input audio data; and
digital output port coupled to the bus, wherein the digital output port outputs at least one of digital output video data, digital text data, and digital output audio data.

36. A multi-function handheld device comprises:
an integrated circuit;
a battery operably coupled to provide a supply voltage to the integrated circuit;
memory operably coupled to the integrated circuit, wherein the integrated circuit includes:
a host interface operable to receive or transmit data with a host device when the multi-function handheld device is operably coupled, via the host interface, to the host device;
a bus operably coupled to the host interface;
processing module operably coupled to the bus, wherein the processing module enables the multi-function handheld device to function in at least one of a first functional mode and a second functional mode, wherein the first functional mode enables the multi-function handheld device to transceived data via the host interface with the host device and wherein the second functional module enables the multi-function handheld device to at least one of playback stored data and record data;
memory interface operably coupled to the bus and memory, wherein, when the multi-function handheld device is in the first functional mode, the memory interface provides received data of the data received from the host device to the memory for storage and provides transmitting data of the data transmitted to the host device from the memory to the host interface via the bus, and wherein, when the multi-function handheld device is in the second functional mode, the memory interface retrieves the stored data from the memory for playback and provides the record data for storage in the memory;
multimedia module operably coupled to the bus, wherein, when the multi-function handheld device is in the second functional mode, the multimedia module processes the stored data for playback and processes the record data for storage in the memory; and
DC to DC converter operably coupled to provide at least a first supply voltage to at least one of the host interface, the processing module, the memory interface, and the multimedia module.

37. The multi-function handheld device of claim 36, wherein the memory further comprises at least one of on-chip memory and off-chip memory.

38. The multi-function handheld device of claim 36, wherein the stored data for playback further comprises at least one of digitized audio data, digital video data, and text data.

39. The multi-function handheld device of claim 36 further comprises:
the first functional mode including the multi-function handheld device functioning as extended memory for the host device;
the second functional mode including a playback mode for playback of stored MP3 data.

40. The multi-function handheld device of claim 36, wherein the memory further comprises at least one of non-volatile memory and volatile memory.

41. The multi-function handheld device of claim 36, wherein the multimedia module further comprises at least one of:
an analog input port for receiving at least one of analog video data and analog audio data;
an analog to digital converter coupled to the bus and the analog input port, wherein the analog to digital convert converts the at least one of the analog video data and analog audio data into digital data;
an analog output port for providing at least one of analog output video data and analog output audio data;
digital to analog converter operably coupled to the bus and to the analog output port, wherein the digital to analog converter converts output digital data into the at least one of analog output video data and analog output audio data;
analog mixer operably coupled to mix one or more of the analog video data, the analog audio data, the analog output video data, and the analog output audio data to produce a mixed analog signal, wherein the mixed analog signal is provided to the analog output port;
digital input port coupled to the bus, wherein the digital input port receives at least one of digital input video data and digital input audio data; and
digital output port coupled to the bus, wherein the digital output port outputs at least one of digital output video data, digital text data, and digital output audio data.
